(19) United States
(12) Patent Application Publication
(10) Pub. No.: US 2009/0323201 A1
(43) Pub. Date: Dec. 31, 2009

(54) Zoom Lens Assembly with Travel Sensor

(75) Inventor: James Bornhorst, De Soto, TX (US)

Correspondence Address: Law Office of Scott C Harris Inc, PO Box 1389, Rancho Santa Fe, CA, 92067, US

(73) Assignee: PRODUCTION RESOURCE GROUP L.L.C, New Windsor, NY (US)

(21) Appl. No.: 12/494,204

(22) Filed: Jun. 29, 2009

Related U.S. Application Data
(60) Provisional application No. 61/076,817, filed on Jun. 30, 2008.

(51) Int. Cl. G02B 7/09

(52) U.S. Cl. 359/695; 359/698

(57) ABSTRACT

Zoom lens assembly formed of a number of lens groups on a track. The lens groups can be moved on the track to form different lens effects such as zoom. The devices sense an end of travel in one direction using a hardware device. All the positions are relative to that end of travel, based on values stored in a memory, and by using the memory to drive the lens groups on the track.

This application claims priority from provisional 61/076,817, filed Jun. 30, 2008, the entire contents of the disclosure of which is herewith incorporated by reference.

### BACKGROUND

A zoom lens system for a stage light can include a number of different individual lenses or elements. Elements are combined into assemblies forming zoom lens groups. The lens groups of the zoom system change position in order to change or zoom the projected beam size of the stage light while maintaining a selected focus during the zooming.

### SUMMARY

Embodiments describe an improved zoom lens assembly.

### BRIEF DESCRIPTION OF THE DRAWING

In the Drawings:

FIG. 1 shows an embodiment of a stage light with lens parts;

FIG. 2 shows more detail about the holder that is holding the zoom lens;

FIG. 3 shows a side view showing the parts and the servo motors;

FIG. 4 shows a calibration flowchart;

FIG. 5 shows a positioning connection with a connection plunger;

FIG. 6 shows details of the plunger; and

FIG. 7 shows a flowchart of moving.

### DETAILED DESCRIPTION

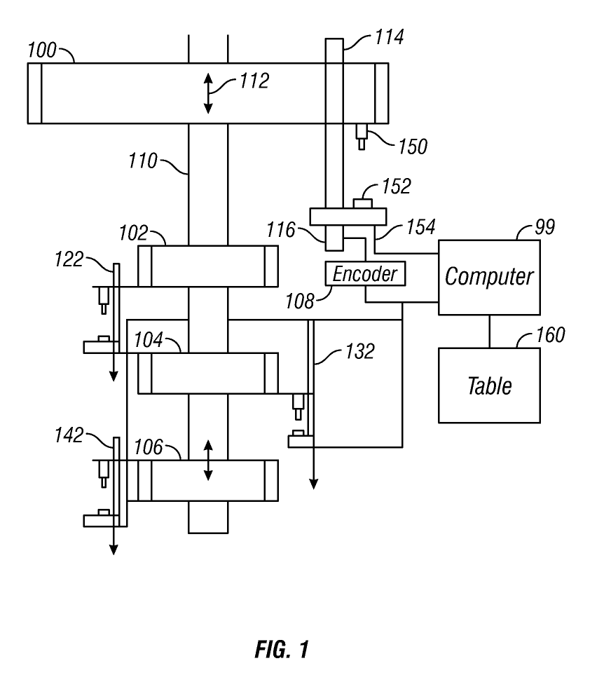

FIG. 1 shows an embodiment which has a computer-controlled zoom lens assembly. A top view of the Zoom lens assembly, with its end of travel sensors, is shown in FIG. 1. The zoom lens system includes a front lens group carrier 100. Other lens group carriers 102, 104, 106 are located optically aligned with the front lens group, such that light passes sequentially through all the groups in the system. The FIG. 1 embodiment shows a four lens group system, but it should be understood that there can be other numbers of groups in the system, e.g, 3 groups, 5 groups, 6 groups, or any other number of lens groups.

Throughout the remainder of the specification, these will be referred to simply as lenses; however, each “lens” can actually be multiple different lenses arranged as a group.

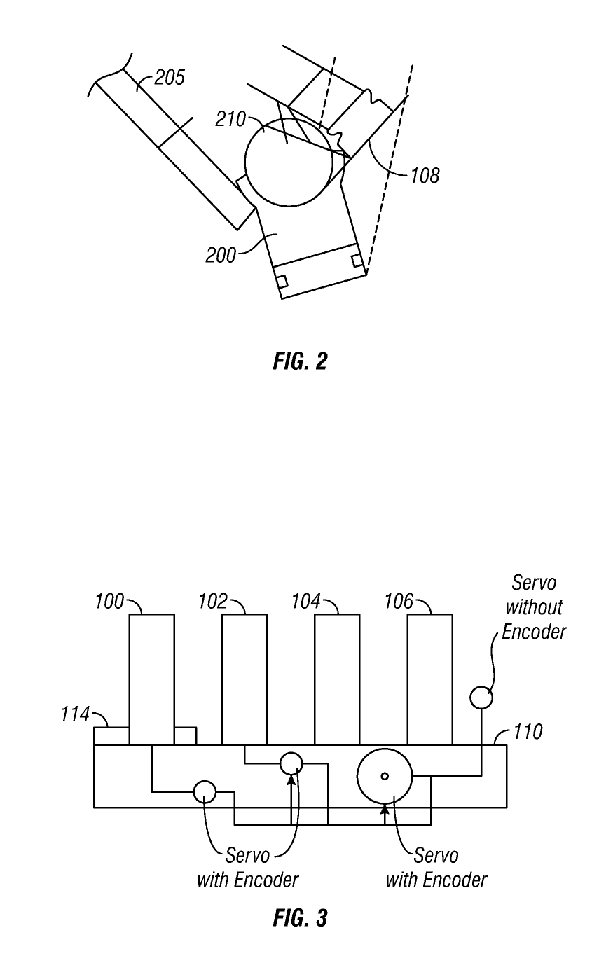

The lenses are not shown in detail, and can be of any type. The elements such as 100, 102, represent the carriers that are holding the lenses, rather than the lenses themselves. The carriers are shown in further detail in FIG. 2. Each carrier such as 200 has an arcuate surface 205 for carrying a lens or group of lenses. The lenses may be held by an opposite facing lens part, or otherwise held therein.

Each of these carriers 100 through 106 are mounted for movement on a track 110 as seen in FIG. 1, and also as seen in FIG. 3. Each of these devices can move along the direction of the track 110. Each of the devices moves separately, as described herein, under control of the software to allow them to move to the proper locations relative to one another on the track for any desired amount of zoom.

The front lens holder 100 moves by action of a threaded screw part 114 which rotates to move the lens carrier in the direction 112. This moves the front lens along the track 110. A pulley part 116 is driven by a precision motor 118. Motor 118 is in turn driven by a computer controller 99.

In a similar way, the lens holder 102 includes a threaded shaft 122. Lens 104 includes a threaded shaft 132. Lens 106 includes a threaded shaft 142. Each of the shafts is driven by a separate servo motor and encoder. Note that alternative elements may have the shafts on alternative sides to prevent the shafts from conflicting with each other.

Precision control over the movement is possible by using the computer 99 to control each motor separately. The control may be according to a table 160 which lists the positions for all lenses along the track for varying degrees of zoom.

The zoom lens system as described herein may be in a remotely controlled luminaire, e.g., a stage light, that is remotely controlled by a console over a computer connection from a remote console. The control may be, for example, over a network connection such as DMX, Artnet or Ethernet. One console can be used to control many different remote lights.

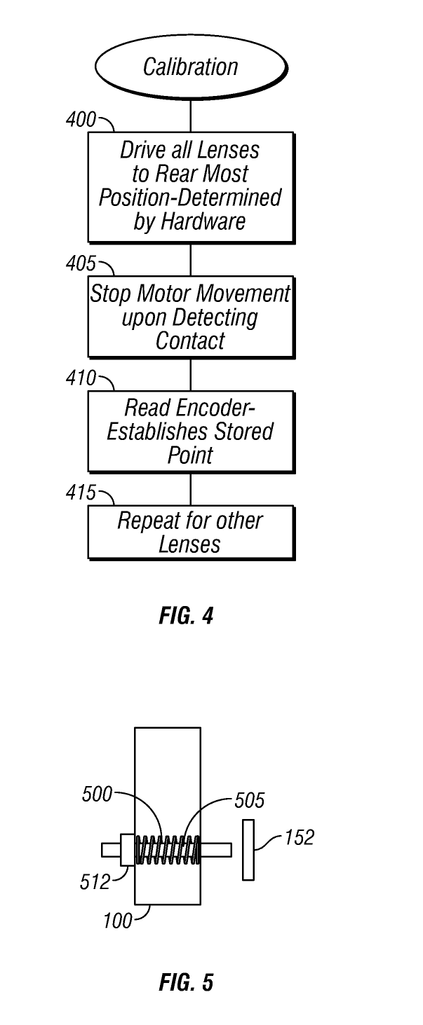

One problem recognized by the inventor is that it may be difficult to determine the locations of the lenses when the lighting device is first powered up. In order to address this problem, first noticed by the inventor, a calibration sequence is defined in the software and shown in the flowchart of FIG. 4.

First, the system takes actions to determine its initial position. Each of the lenses has a home position defined by their rearmost positions of travel. These positions are illustrated by the most downward position in FIG. 1. In operation, on initial startup, each of the lenses are driven to that rear-most position 400. 400 shows driving those contacts until there is a hardware interaction. When driven into that position, referred to herein as the “home” position, a precision contact 150 comes into contact with the corresponding contact portion 152 on a device that has been located into the proper location.

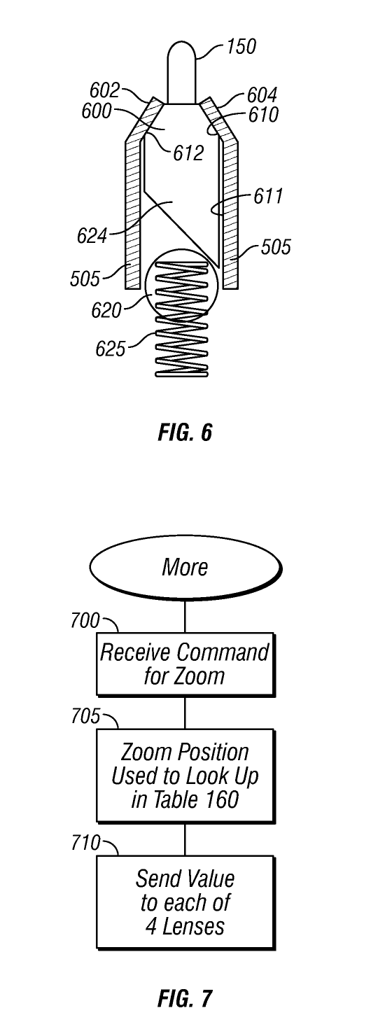

FIG. 5 shows a detail of the precision contact including the contact 150 on the lens holder 100. The contact 150 is spring loaded with a spring element inside a plunger assembly 505 as shown in FIG. 6.

In an alternative embodiment, the contact may be driven to its frontmost direction.

The contact 150 is shown attached to a body portion 600 that has tapered shoulders 602, 604. When the contact 150 is in its forward most position, the tapered shoulders 602, 604 fit against the corresponding sections 612, 610 on the inside surface 611 of the plunger. The tapered shoulders 602, 612, for example, may form a 45° angle with respect to the forward most direction which ensures that the contact always returns to the same forwardmost position.

The bottom portion is also biased by a ball 620 that presses against a spring 625. The bottom surface of the body portion 600 has a wedge shaped portion 624 which has for example a 45° angle relative to the forward direction. The edge surfaces of the body 624 are sized relative to the inner surfaces of the plunger, thereby maintaining the plunger always straight inside the body.

The ball presses against this 45 degree surface, with an edge surface of the coil 620 pressed against the inside surface of the plunger. This thereby keeps even pressure on the body. The ball and spring 625 force electrical contact between the body 600 and the plunger 625. The tapered shoulders 602, 604 fit against mating surfaces 610, 612 on the inside surface of the plunger 505.

Once the contact 150 comes into contact with the corresponding point 152 on the circuit board, it produces a signal 154, which is coupled to the computer 99. The computer 99 immediately stops the action of the motor at 405. The computer also reads the position of the stopped lens from the encoder 108 at 410. The position of the stopped lens is established as the home position.

The contact 152 on the circuit board may have a spring action also, to avoid denting the contact when the point hits it. Also, there can be a calibration screw 512 that allows setting the fine position of the contact.

Each of the lens holders 100, 102, 104, 106 can be driven into their home position in an analogous way, and the encoder value stored at 415.

Once the positions of the lenses are known from 415, the servomotors can be controlled so that each of the four lens parts are moved separately according to position instructions in a table 160. The computer 99 stores a table 160 that indicates for a number of zoom positions, proper focus locations for each of the four lenses in the lens group system. A user can command different amounts of zoom, while still maintaining everything in focus by using the values in the table 160. For example, for zoom 0, (minimum zoom) the table can store positions for each of the lenses, e.g., 45, 60, 33, 12 (each being numbers that represent the position of the motor encoders and subsequently, positions along the track). Each of these numbers can be determined by trial and error. For example, for each of plural different zoom locations, an entry can be made in the table 160. That entry can include the zoom number (100%, 90%, etc, or using whatever alternative terminology might be used to indicate different zoom locations).

Unlike other zooming systems, this system, allows all the elements to move, that is all the four lens groups of the zoom lens, and the software controls the position of each lens.

In operation, once the calibration operation of FIG. 4 is carried out it does not need to be carried out again until the fixture is again powered down and restarted. FIG. 7 shows a flowchart of the operation. At 700, a command is received for a desired position. The zoom position is used at 705 to look up values for each of the lenses in the table 160. This provides a value for each of the four lenses, and at 710, that value is sent by the processor to each of the four lenses, and each of the motors drives each of the four lenses to specify the amount of movement for each of these lenses. This can zoom to any desired position, so long as the values for that zoom position are stored in the table 160.

Preferably calibration only needs to be carried out once upon initial turn on the light. However, calibration can be carried out more often if desired.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other numbers of lenses and lens groups can be used, e.g, 3 lens groups, 5 lens groups or any other number. Moreover, this system can be used to move lens groups which have functions other than a zoom lens.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The system described herein can be controlled by any kind of computer, either general purpose, or some specific purpose computer such as a workstation.

The programs may also be run over a network, for example, with a server or other machine sending signals to the local machine, which allows the local machine to carry out the operations described herein.

What is claimed is:

1. A device, comprising:
a lens set formed of a first lens assembly, a second lens assembly and a third lens assembly;
a track with surfaces for moving said first, second and third lens assemblies; and
a first motor, coupled to move said first lens assembly, and a first position detecting device detecting a position of said first lens assembly; a second motor coupled to move said second lens assembly and a second position detecting device coupled to detect the position of said second lens assembly; and a third motor coupled to move said third lens assembly and a third position detecting device coupled to detect a position of said third lens assembly; and
a processor, having an associated memory which stores plurality of different lens positions which maintain said lens set formed by said first lens assembly, second lens assembly and third lens assembly in focused positions relative to one another at multiple different positions along said track, said processor outputting signals which cause each of said first lens assembly, second lens assembly and third lens assembly to move based on an entry indicative of a lens assembly position.

2. The device as in claim 1, wherein said lens set forms a zoom lens, and said lens assembly position is a degree of zooming, and where said positions of each of said first, second and third lens assemblies keep said set in focus at said degree of zooming.

3. A device as in claim 2, wherein said lens set also includes a fourth lens assembly as part of said lens set.

4. The device as in claim 3, wherein said processor output signals cause each of said first, second, third and fourth lenses to move to a new position and stay in focus at said new position.

5. A device as in claim 1, further comprising first, second and third end of travel sensors that each detect when said first, second and third lens assemblies have reached a specified end of travel position.

6. A device as in claim 5, wherein said processor carries out an initial calibration routine, by commanding each of said lenses to said end of travel position, monitoring said position detecting devices to determine the position of each lens at the end of travel position, and wherein said information in said table is relative to said end of travel position.

7. A device as in claim 5, wherein said end of travel sensors include a contact on said lens assembly, and a corresponding contact located at the position at said end of travel.

8. A device as in claim 3, wherein said first, second, third and fourth lenses are moved for different zoom positions.

9. A device as in claim 1, wherein each of said first, second and third lens assemblies is a lens group including multiple lenses.

10. A method, comprising:
positioning first, second and third lenses along a track;
moving said first, second and third lenses along said track;
said moving carried out by a processor which output signals indicative of said moving, said processor having a table of different positions for each of said lenses, and for a number of different lens effects for said lenses, where said processor outputs signals for each of said lenses which maintain them in focus for each of said plurality of different lens effects.

11. A method as in claim 10, wherein said lens effects are different zooms of a zoom lens formed by said first, second and third lenses.

12. A method as in claim 11, further comprising a fourth lens, and wherein said processor output signals for moving said forth lens based on said different zooms.

13. A method as in claim 12, wherein each of said first, second, third and fourth lenses are moved for different positions of zoom.

14. A method as in claim 10, wherein each of said first, second and third lenses include multiple parts forming a lens group.

15. A device, comprising:
a lens set formed of a first lens assembly, a second lens assembly and a third lens assembly;
a track with surfaces for moving said first, second and third lens assemblies; and
a first motor, coupled to move said first lens assembly, and a first position detecting device detecting a position of said first lens assembly and a first end of travel device which produces a signal indicating an end of travel of said first lens assembly on said track; a second motor coupled to move said second lens assembly and a second position detecting device coupled to detect the position of said second lens assembly and a second end of travel device which produces a signal indicating an end of travel of said second lens assembly on said track; and a third motor coupled to move said third lens assembly and a third position detecting device coupled to detect a position of said third lens assembly and a third end of travel device which produces a signal indicating an end of travel of said third lens assembly on said track; and
a processor, carrying out an initial calibration routine which drives said first, second and third lens assemblies until detecting each end of travel signal from each of said first, second and third lens assemblies, reads information from said position detecting device indicative of said end of travel positions of each of said first, second and third lens assemblies, and thereafter, moves each of said first, second and third lens assemblies by an amount relative to said end of travel positions of first, second and third lens assemblies.

16. A device as in claim 15, further comprising an associated memory which stores plurality of different lens positions which maintain said lens set formed by said first lens assembly, second lens assembly and third lens assembly in focused positions relative to one another at multiple different positions along said track, said processor outputting signals which cause each of said first lens assembly, second lens assembly and third lens assembly to move based on an entry indicative of a lens assembly position, each of said positions being relative to said end of travel position.

17. The device as in claim 16, wherein said lens set forms a zoom lens, and said lens assembly position is a degree of zooming, and where said positions of each of said first, second and third lens assemblies relative to said end of travel position keep said set in focus at said degree of zooming.

18. A device as in claim 15, wherein said lens set also includes a fourth lens assembly as part of said lens set.

19. The device as in claim 18, wherein said processor output signals cause each of said first, second, third and fourth lenses to move to a new position relative to said end of travel position and stay in focus at said new position.

20. A device as in claim 13, wherein said end of travel devices include a contact on said lens assembly, and a corresponding contact located at the position at said end of travel.

21. A device as in claim 13, wherein said end of travel devices include a hardware device that detects a physical position.

22. A device as in claim 13, wherein each of said first, second and third lens assemblies is a lens group including multiple lenses.
